(19) United States
(12) Patent Application Publication
(10) Pub. No.: US 2015/0281820 A1
(43) Pub. Date: Oct. 1, 2015

(54) AUDIO HEADSET HAVING WIRE GUIDED EAR BUDS

(71) Applicant: PointSource Audio, Inc., Petaluma, CA (US)

(72) Inventors: James Lamb, Novato, CA (US); Yvonne Ho, Novato, CA (US)

(73) Assignee: PointSource Audio, Inc., Petaluma, CA (US)

(21) Appl. No.: 14/225,247

(22) Filed: Mar. 25, 2014

(51) Int. Cl. H04R 1/10

(52) U.S. Cl. CPC H04R 1/105; H04R 1/1058

(57) ABSTRACT

An audio headset includes a support structure, one or more audio feed wires, one or more ear buds or other single ear speakers coupled thereto, and one or more ear guides adapted to be worn about the ear(s) of an individual user. The ear guide(s) include groove(s) running therethrough that contain the audio feed wire(s) for the speaker(s), such that each respective speaker dangles from its ear guide thereby. Groove(s) can also contain part of the support structure, and the ear guide(s) may extend beyond the ear regions to the point of meeting each other. Each speaker can be removed from and replaced to the ear of the user independently while the headset is being worn without requiring movement or adjustment of the support structure or ear guide. Each groove can include a plurality of openings that allow adjustment where the wire exits, and each wire and respective speaker are readily separable, removable, and replaceable from the headset without requiring disassembly of or disturbance to the remainder of the headset.

### TECHNICAL FIELD

The present invention relates generally to sound technology equipment, and more particularly to personal headsets adapted to provide audio to individuals.

### BACKGROUND

Personal headsets for audio systems have been in use for many years, and for a variety of different professional applications. Professional and other advanced applications for good audio headsets can include those that are used by, for example, telephone operators, dispatchers, airplane pilots, drone operators, video camera operators, studio mixers, and professional sound technicians, among other various possibilities. In many such occupations and applications, it may also be desirable for such audio headsets to also have microphones so as to facilitate two-way communications, although this is not always necessary.

It is generally well known that audio headsets for such professional and other advanced applications tend to be of higher quality than the relatively cheap or common types that tend to be used by music listeners or other typical consumers. Speakers for such higher quality headsets tend to be more sophisticated, made from higher quality materials, and can even have advanced features that are not found in typical consumer headsets. Such features can include ambient noise reduction or cancellation, improved clarity, larger sound ranges, and greater user comforts, among other items.

Unfortunately, there are several drawbacks that are typical to many of these professional and higher end audio headsets. For one thing, many tend to be quite bulky or cumbersome, are often large enough to completely cover both ears of the individual user, and can be uncomfortable to wear for an extended period of time. Some also do not integrate a microphone very well, particularly with respect to those that are particularly large or bulky. In response to these particular issues, there are some audio headsets that may incorporate smaller speakers and/or other components that make for a more lightweight product.

Such solutions can give rise to additional problems, however, as noise interference may rise, sound quality may decline, and any introduction of exposed wires can result in tangling or other inconveniences. Also, issues can still remain with respect to users needing to remove or adjust the entire headset if they wish to listen or communicate locally or off set, even for a few seconds. Furthermore, such solutions tend to include loudspeakers and other components that are not readily replaceable within the overall headset. When one or both of loudspeakers becomes damaged or otherwise loses quality, the entire headset must then be replaced. This tends to be relatively expensive and inconvenient, particularly for high end solutions.

While audio headsets and systems therefor have worked well in practice over many years, there is always a desire to improve the functionality, efficiency, comfort, and security of such devices and supporting systems. What is desired then are improved audio headsets and components therefor, particularly with respect to the ability to provide high quality sound to users in a lightweight and customizable manner that is flexible and that includes components that can be readily and quickly removed, reinstated and even replaced with little effort by the user.

### SUMMARY

It is an advantage of the present disclosure to provide improved audio headsets, particularly with respect to those that are lightweight and have one or more components that are relatively expensive or costly. This can be accomplished at least in part through the use of headsets having lightweight frames, high quality insertable ear buds, and ear guides having grooves therein to guide the ear bud wires, such that the ear buds can be readily removed and reinserted into the ears of the users without needing to adjust anything else on the headset.

In various embodiments of the present disclosure, an audio headset adapted to provide audio to an individual user can include a support structure adapted to support the audio headset about the head of the individual user, an audio feed wire situated about the support structure and adapted to provide audio from an outside source to the individual user, a single ear speaker coupled to the audio feed wire and adapted to provide the audio from the audio feed wire to a single ear of the individual user, and an ear guide coupled to the support structure and adapted to be worn about the single ear of the individual user. In particular, the ear guide can be further adapted for use with the single ear speaker and can include a groove running therethrough that is adapted to contain the audio feed wire.

In various detailed embodiments, the single ear speaker can be an ear bud adapted to be inserted into the single ear of the user. Also, the ear bud or other single ear speaker can be arranged to be removable from and replaced to the single ear of the user while the rest of the audio headset is being worn by the user and without requiring any movement or adjustment of the support structure or ear guide. Further, the single ear speaker can dangle from the ear guide via the audio feed wire. The audio headset can also include a microphone coupled to the support structure or the ear guide, and adapted to provide voice input from the user to the outside source. Also, the audio feed wire and single ear speaker can be readily separable, removable, and replaceable from the ear guide and the remainder of the audio headset.

In various embodiments, the groove can include a rear opening at or near a back of the ear guide, and can run substantially through the ear guide length to a frontal opening at or near the front of the ear guide. In fact, the groove can include a plurality of frontal openings at or near the ear guide front end, in which case the audio feed wire can be adjustable to alter its exit of the groove at different frontal openings as may be desired by the user.

In various detailed embodiments, the headset can also include a second audio feed wire situated about the support structure and a second single ear speaker coupled thereto, with both being adapted to further provide the audio from the outside source to the individual user. A second ear guide coupled to the support structure and adapted to be worn about the other ear of the individual user can be used with the second single ear speaker, and can include a second groove running therethrough that is adapted similarly to contain the second audio feed wire. In such embodiments, the first and second single ear speakers can include separate ear buds adapted to be inserted into the ears of the user independently from each other. Also, the first ear guide, second ear guide, or both, can extend around the head of the user to meet each other thereby, in which case the first and second groves can meet or connect with each other, such that one extended groove is formed thereby. In such cases, the first and second ear guides can be integrally formed from a single piece of material.

In further embodiments, an audio system can include an audio source processor, as well as one or more audio headsets such as any of those set forth above. It will also appreciated that in such audio systems, or in any of the standalone headset embodiments, that any of the foregoing features may be included or excluded as may be desirable.

In still further embodiments, various methods of providing audio to an individual user are disclosed. Pertinent process steps therefor can include providing an audio headset having an ear bud to the individual user, facilitating the wearing of an ear guide therefrom about the ear of the user such that the ear bud dangles therefrom via an audio feed wire, and providing audio into the ear of the individual user when the ear bud is inserted into the ear of the user. Such an audio headset can be any of those set forth above, with any combination or lack of disclosed features as may be desired and applicable. For example, the ear guide can have a groove running therethrough that contains an audio feed wire that feeds audio to the ear bud.

Other apparatuses, methods, features and advantages of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed inventive apparatuses, systems and methods for audio headsets having wire guided ear buds. These drawings in no way limit any changes in form and detail that may be made to the disclosure by one skilled in the art without departing from the spirit and scope of the disclosure.

FIG. 1A illustrates in side perspective view an exemplary audio headset according to one embodiment of the present disclosure.

FIG. 1B similarly illustrates in side perspective view the exemplary audio headset of FIG. 1A, but on a modeled head according to one embodiment of the present disclosure.

FIG. 2A illustrates in top perspective view an exemplary grooved ear guide and coupled ear bud according to one embodiment of the present disclosure.

FIG. 2B similarly illustrates in top perspective view the exemplary grooved ear guide of FIG. 2A, but with a coupled replacement ear bud according to one embodiment of the present disclosure.

FIG. 3 illustrates in top plan view an exemplary ear guide having multiple exit grooves according to one embodiment of the present disclosure.

FIG. 4 illustrates in side perspective view an alternative exemplary audio headset having extended ear guides according to another embodiment of the present disclosure.

FIG. 5 provides a flowchart of an exemplary method of providing audio to an individual user according to one embodiment of the present disclosure.

### DETAILED DESCRIPTION

Exemplary applications of apparatuses and methods according to the present disclosure are described in this section. These examples are being provided solely to add context and aid in the understanding of the disclosure. It will thus be apparent to one skilled in the art that the present disclosure may be practiced without some or all of these specific details. In other instances, well known process steps have not been described in detail in order to avoid unnecessarily obscuring the present disclosure. Other applications are possible, such that the following examples should not be taken as limiting.

In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to devices, systems and methods for providing high quality audio to an individual via a personal audio headset. As such, this disclosure may be applied to any personal audio headset, headphones, or other audio equipment worn by a user for any audio application. Such applications may include, but are not limited to, telephone operators, dispatchers, call center operators, airplane pilots, drone operators, video camera operators, studio mixers, professional sound technicians, and intercom users, among other various possibilities. As one particular non-limiting example, the present disclosure can apply to two-way radio intercom communications.

While the present disclosure contemplates the use of a high quality personal audio headset, other sound components may also be included. Such components, can include, for example, microphones, transmitters, receivers, audio processors, equalizers, synthesizers, sound analysis components, telecom devices, and the like.

Although the present disclosure provides the example of a two ear bud headset with a connecting support structure and microphone for purposes of illustration, it will be readily appreciated that other physical ear pieces, headsets, and other related components or elements may be similarly used, with or without such microphones and other associated items. Alternatively, or in addition to ear buds, other audio elements and structural components can include, for example, feed wires, transmitters, receivers, pads, ear muffs, wire clips, and the like.

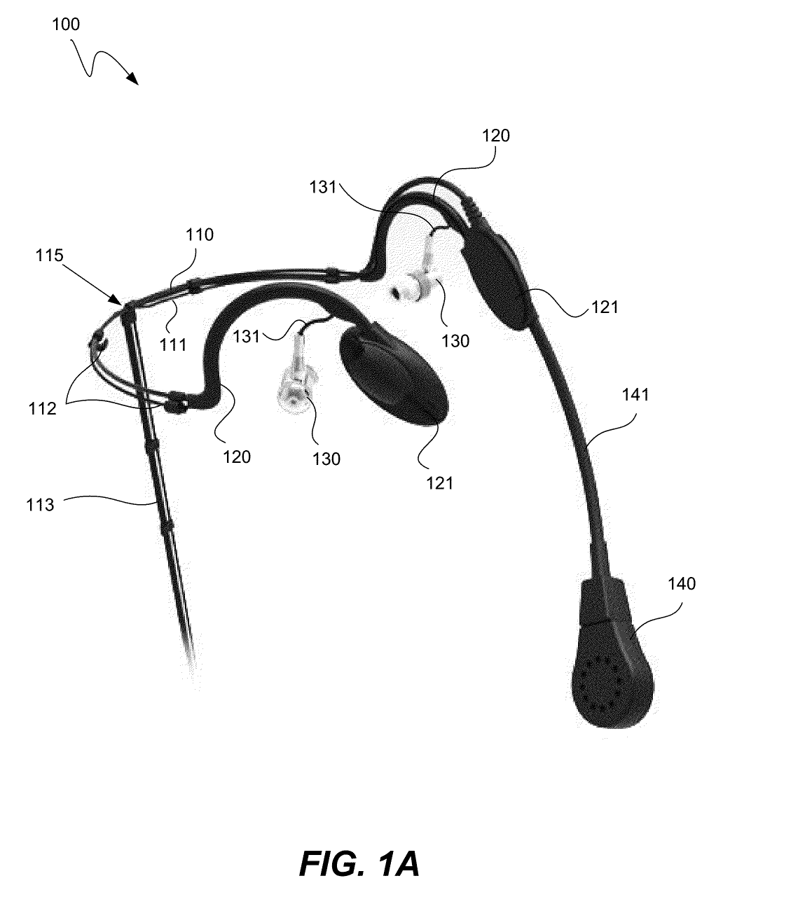

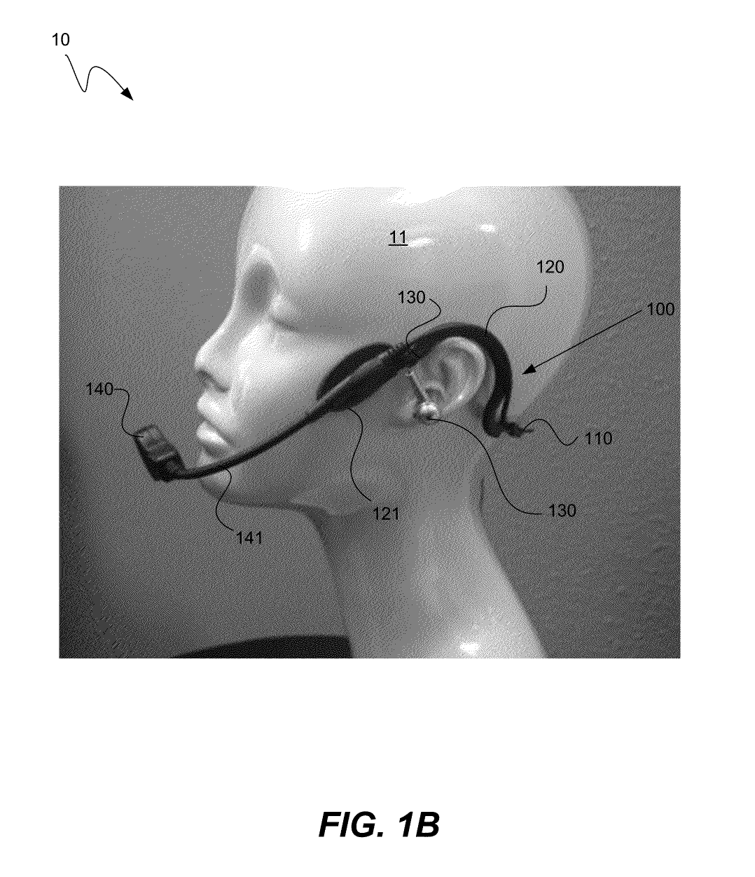

In general, the present disclosure can pertain to an audio headset or an associated audio system including such a headset. Referring first to FIGS. 1A and 1B, an exemplary audio headset according to one embodiment of the present disclosure is illustrated in side perspective views both in isolation and as would be worn on a modeled head. It will be readily appreciated that audio headset 100 can include a variety of items and components, both in addition to and in lieu of those shown by way of example here. As shown, headset 100 can include a frame or support structure 110, which can be a rigid solid component, flexible metal band, or other item adapted to provide stability to and connect the various other headset components. Such a support structure can guide and/or support one or more audio feed wires 111, such that audio can be provided to the various speakers and/or from the microphone on the headset, such as to and from a wireless transceiver (not shown) located on or about the headset. Such a transceiver might be located at a back connecting location 115, or such a location might provide a coupling point for the audio feed wires to extend further beyond the audio headset along an external support or guide 113, as shown. One or more clips 112 can couple the audio feed wire(s) 111 to the metal band or other support structure 110 in one or more strategic locations, as may be helpful.

One or two ear guides 120 can be coupled to the support structure 110, with such ear guides being adapted to be worn about the ear of a user when the headset 100 is in normal use. Such ear guides 120 can include one or more stabilizing components 121 that can be used to assist with a snug or adjusted fit of the headset against the head 11 of the user, as is shown in the worn headset arrangement 10 depicted in FIG. 1B. Ear guides 120 can be formed from a solid silicone, plastic, or other similar material, among other possible examples, so as to provide structural rigidity without also sacrificing comfort to the user. Ear guides 120 can also include one or more grooves therein or therethrough (not shown here) to allow one or more of the audio feed wires 111 to be guided about the head and ear(s) of the user in a nonobtrusive manner.

At one or more locations on the ear guide(s) 120, an audio feed wire end 131 can exit and drop away from the ear guide, with an ear bud 130 or other suitable speaker for the ear of the user coupled to the audio feed wire 131. In this manner, one or two ear buds 130 can be inserted into the ear(s) of a user as they dangle from the ear guide(s) 120 via the audio feed wire(s) 131, while the entire headset 100 is worn by the user, as shown in FIG. 1B. An optional microphone 140 can also be coupled to the support structure 110 or other headset component by way of a microphone boom 141. An associated microphone wire (not shown) can be included inside or alongside the boom 141.

As shown in the worn headset arrangement 10 in FIG. 1B, the ear buds 130 are arranged such that they can be inserted into and removed from the user without disturbing the remainder of the headset 100. That is, the support structure 110, ear guides 120, stabilizing components 121, microphone 140, and other headset components can all remain in place and undisturbed while the user is able to insert and remove the ear buds 130 as may be desired for intermittent and changing attention to that which is being broadcast over the headset 100, and then rest and/or attention to ambient sounds. Such an arrangement is particularly advantageous with respect to the ease and quickness of the change, as well as the ability to leave one ear bud in while removing the other one for a short time, as may be desired by the user. The relative ease and quickness with regard to reinserting and using a temporarily removed ear bud is then beneficial, without any undue need to adjust and acclimate an overall bulky headset in order to reenter a listening mode. Similarly, the advantageous ability to remove and replace one or both ear buds 130 from the headset 100 itself is relatively simple as well, as set forth in greater detail below.

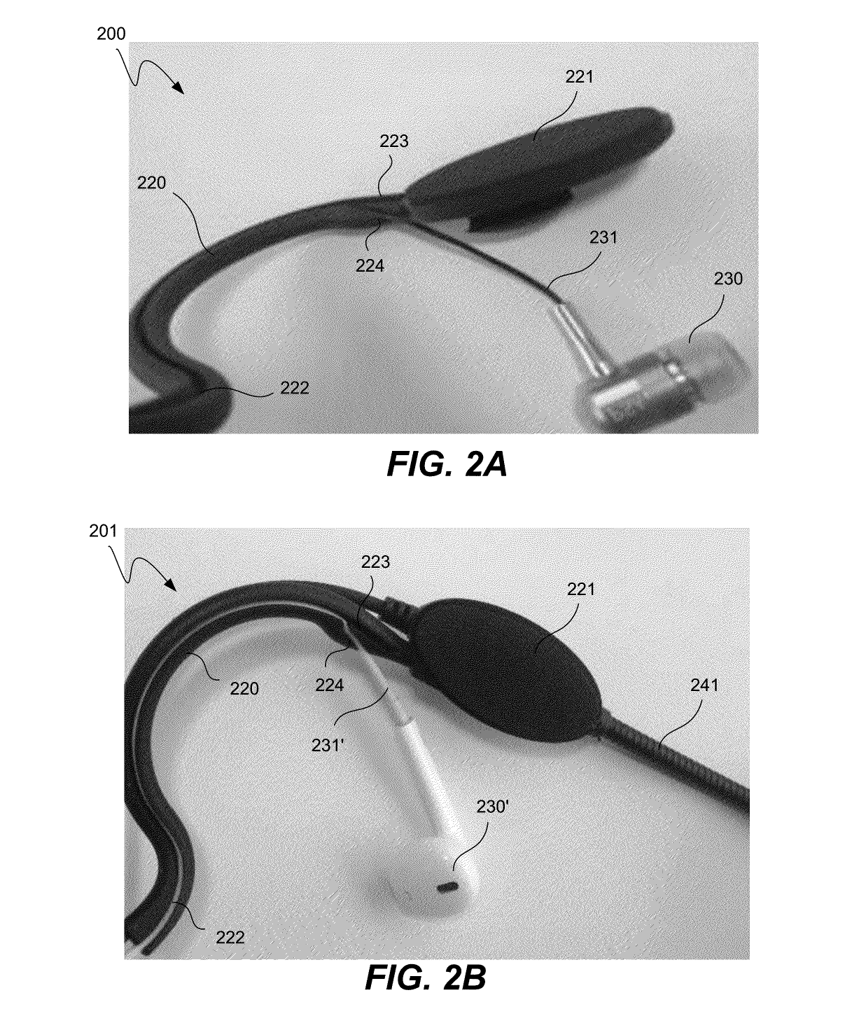

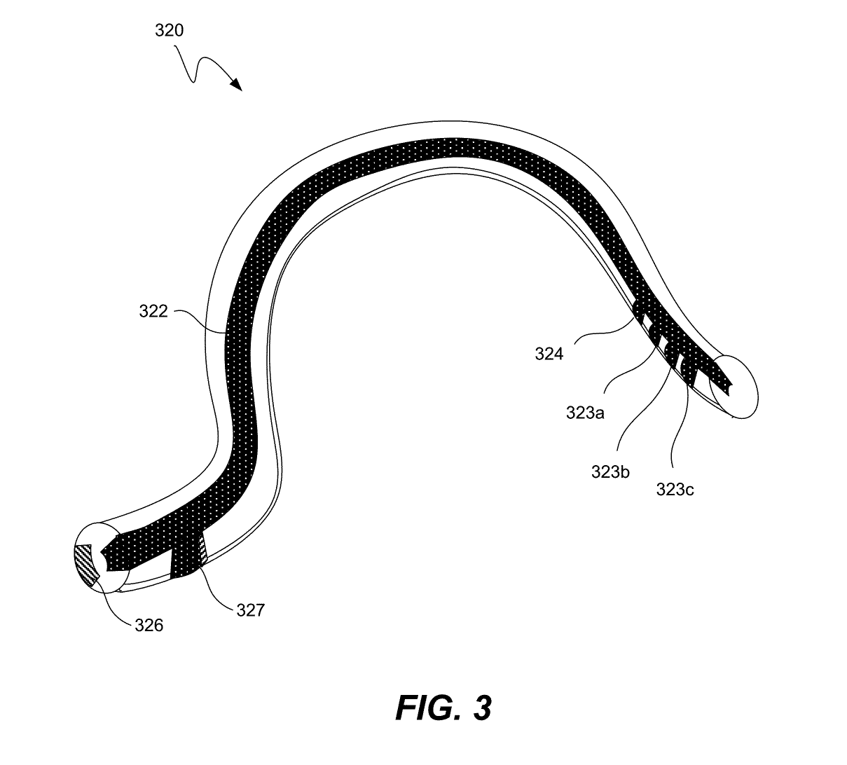

Continuing with FIGS. 2A and 2B, an exemplary grooved ear guide with different coupled ear buds is shown in top perspective views. It will be readily appreciated that headset portion 200 can be similar or identical to various components that are shown above with respect to overall headset 100. As shown, an ear guide 220 can have a stabilizing component 221 similar to that shown above, and can also have a groove 222 running therethrough, with the groove being adapted to contain and support a portion of an audio feed wire 231 therein. At an exit region of the ear guide 220, the groove 222 can split off or otherwise exit at exit groove 224, such that the audio feed wire can exit the ear guide 220 at this location. An ear bud 230 can then be coupled to the audio feed wire 231 such that the ear bud and audio feed wire dangle from the ear guide 220 at the location where the wire exits at exit groove 224.

One or more alternative exit grooves 223 can also branch out from the main groove 222 running through the ear guide 220. Such alternative exit grooves could also be used as the actual exit point from the ear guide 220 for the audio feed wire 231. In this manner, the exit point for the wire 231 from the ear guide can be adjusted to suit the size and preferences of the user. While some users might want the ear bud 230 and wire 231 to dangle from an earlier point along the ear guide 220, other users might want these items to dangle from an alternative exit groove 223 located farther along the ear guide. A simple removal of the wire 231 from exit groove 224 and insertion into an alternative exit groove 223 (or other) can then provide for such an adjustment.

Headset portion 201 shown in FIG. 2B can be substantially similar to that shown in FIG. 2A. In fact, the ear guide 220 and associated components can be the same, such as where the ear bud and coupled audio feed wire have been replaced. Given the nature of the grooved ear guide, ear bud, audio feed wire, and other associated components, it will be readily appreciated that the ear bud 230 and coupled audio feed wire can be readily replaced with other such parts, without undue disassembly or disturbances to the remainder of the overall audio headset. As shown in portion 201, the original ear bud and audio feed wire have been replaced with ear bud 230′ and coupled audio feed wire 231′. This can be accomplished simply by removing the audio feed wire 231 from the groove 222, and then disconnecting or otherwise uncoupling the other end of the audio feed wire (not shown) at the proper location upstream on the headset. The replacement feed wire 231′ can then be coupled at this location and inserted into the groove 222, with the exit from the groove being threaded at the desired location. Again, this is at exit groove 224 here for purposes of illustration.

In FIG. 3, an exemplary ear guide having multiple exit grooves is depicted in top plan view. Ear guide 320 can be part of an overall audio headset, such as any of the headsets set forth herein. In such headsets, an ear bud or other similar speaker (not shown here) can be adapted to hang from the ear guide 320 by way of an audio feed wire (not shown here), such as that which is set forth in other examples herein. Such an arrangement can be facilitated by the ear guide 320 having one or more grooves 322 that run therethrough, with such groove(s) being adapted to contain one or more audio feed wires. Groove 322 can run substantially along the length of the ear guide 320, such that an audio feed wire can enter the groove at one end of the ear guide and exit the groove at an exit location toward the other end of the ear guide. Such an exit location can be at exit groove 324, for example.

Alternatively, the exit location can be at any of a number of alternative exit grooves 323a, 323b, 323c, which can be located at various places along and branching off from the main groove 322. In various embodiments, the user can adjust the feed wire such that it exits the ear guide at an exit groove that is fitted for and/or comfortable for the user. Similarly, the entrance location for the feed wire into groove 322 can be at a distal end of the ear guide 320, or at any of one or more alternative entrance grooves, such as entrance groove 327. Again, such alternative entrance grooves can be located at various places and branching off from main groove 322, such that the user can feed the audio wire into and out of groove 322 within ear guide 320 according to the comfort and desires of the user.

In addition, a frame or support structure (not shown here) can also be adapted to couple to the ear guide, such as by way of a coupling notch, groove, or other connecting feature 326 that can be located at a back end of the ear guide. Such a coupling can be made so that the ear guide 320 can be readily disassembled or uncoupled from the frame, support structure, or other overall headset component. In various embodiments, a microphone boom (not shown) may also be coupled to one end of the ear guide 320, such that a microphone can be coupled to either a left or right ear guide, per the preferences of the individual user.

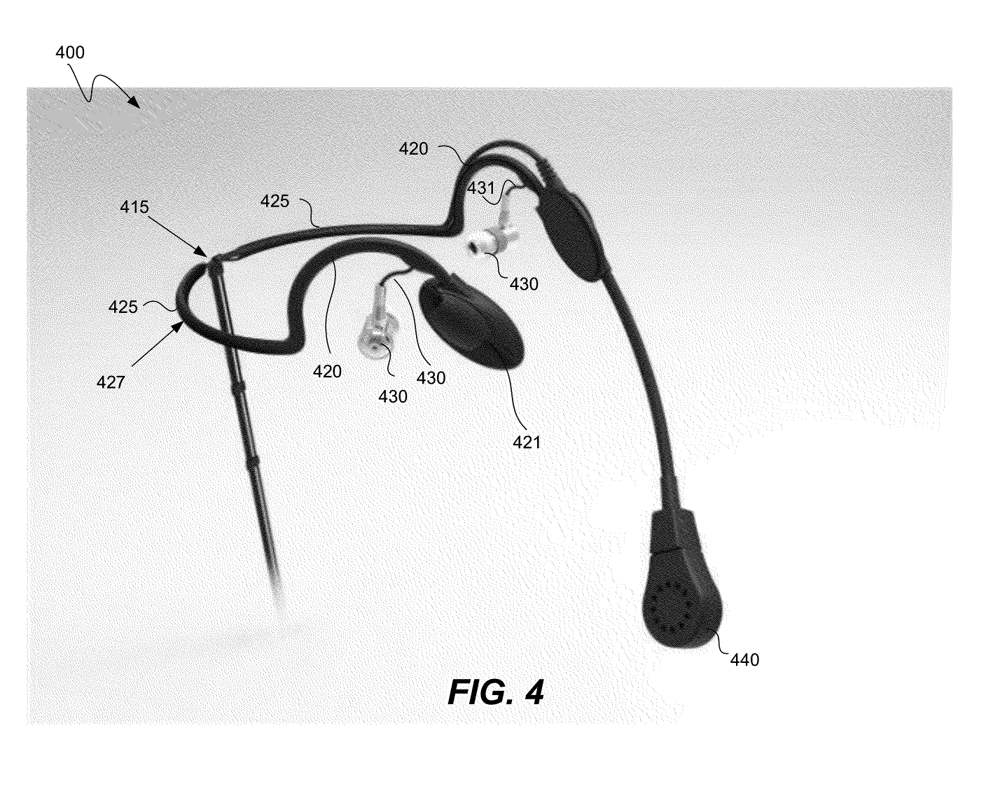

Moving next to FIG. 4, an alternative exemplary audio headset having extended ear guides according to another embodiment of the present disclosure is similarly shown in side perspective view. Audio headset 400 can be substantially similar to the foregoing audio headsets in many regards. For example, headset 400 can include one or two ear guides 420 having stabilizing components 421 adapted to facilitate a good fit to the head of a user, as well as one or two ear buds 430 or other suitable speakers coupled to audio feed wire(s) 431 that exit from a groove located in the ear guide(s) 420. The audio feed wires can meet at a back location 415, where they may then extend away from the overall headset 400, and/or couple to a transceiver for wireless communications. A microphone 440 can also be coupled to one of the ear guides 420 if desired.

Unlike the foregoing embodiments, ear guide(s) 420 can extend well past the ear of the user and around the back of the head of the user. Such an ear guide extension portion 425 can also contain an extension of the groove inside the ear guide 420 that contains the audio feed wire(s). In some embodiments, such ear guide extension(s) 425 can provide added stability to the overall headset 400, in addition to providing further protection to and added aesthetics with respect to containing and guiding the audio feed wire(s). In various embodiments, a flexible metal band or other support structure (not shown) can be embedded within the ear guide extension(s). This can be accomplished by using a separate groove or other embedded cavity to contain the support structure. Such an arrangement can provide further support and rigidity to the overall audio headset 400, while still maintaining a relatively light, strong, flexible, and aesthetically pleasing item.

Similar to the foregoing embodiments, ear guide 420 can have multiple entrance and/or exit groove locations to choose from, such that a user can choose to have the audio feed wire enter and exit the groove within the ear guide at locations that are comfortable and beneficial to the customized needs or desires of the user. For example, rather than having the wire extend through the groove all the way to the back distal end of ear guide 420 near back connecting location 415, the audio wire might enter the ear guide at entry location 427, where a suitable entry groove (not shown) might be located. Other entry grooves and entry groove locations might also be used.

Furthermore, two ear guide extensions 425 may meet at back connecting location 415, such that both ear guides 420 might be connected or even integrally formed from a single piece of material. Alternatively, the ear guide extensions 425 may stop short of meeting at location 415, as shown, such that the ear guides and grooves contained therein are actually separate components that come close to each other but do not actually connect. In such embodiments, the audio feed wire(s) may be detachably connected to a plug in point at or near connecting location 415, such that individual wires and speakers can be readily removed and replaced when desired. Of course, any other shortened distance for ear guide extensions 425 may also be used, such that further customizations and adjustments of the overall headset 400 for different users and head sizes may take place.

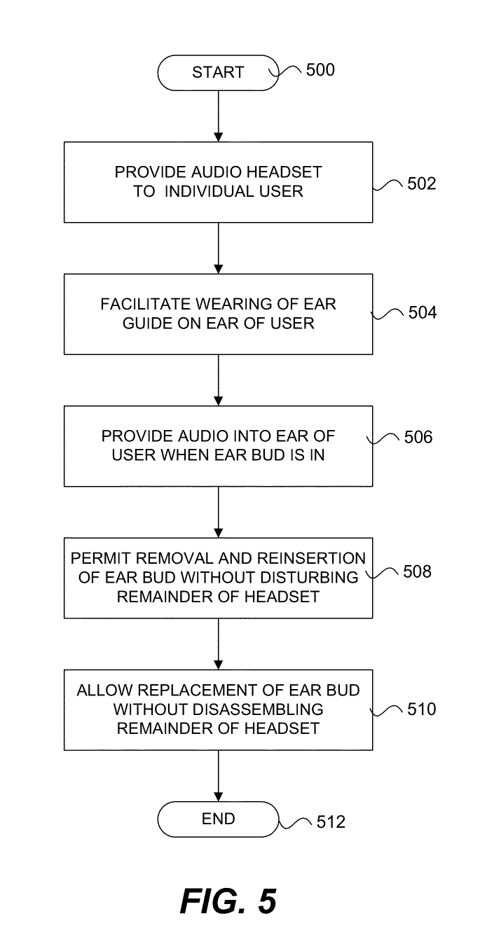

Moving lastly to FIG. 5, a flowchart of an exemplary method of providing audio to an individual user is provided. After a start step 500, a suitable audio headset is provided to a user at process step 502. Such an audio headset can be any of those that are described in greater detail above, with any combination of the foregoing features, as may be desired. For example, an audio headset having one or two ear guides that have groove(s) running therethrough that contain audio feed wire(s) may be used. In addition, one or two ear buds that dangle from the ear guide(s) by way of the audio feed wire(s) may also be used.

Another process step 504 involves facilitating the wearing of the ear guide on an ear of the individual user. In particular, such a wearing can be done so that an ear bud dangles therefrom via the audio feed wire and is insertable into the ear of the individual user. At a following process step 506, audio can be provided into the ear of the individual user via the ear bud when the ear bud is inserted into the ear of the user. This can be done, for example, by transmitting or otherwise providing audio to the overall headset, whereby the audio is fed by the audio feed wire(s) to the ear bud(s) inside the ear(s) of the user.

At an optional process step 508, the removal and reinsertion of one or both ear buds can be permitted. Again, such a removal and reinsertion can preferably be accomplished without any need to disturb or adjust the remainder of the headset. At another optional process step 510, the replacement of an ear bud can be allowed. Similarly, the replacement of an ear bud with a new ear bud can preferably be accomplished without disassembling the remainder of the headset. This can be done, for example, by disconnecting one end of the feed wire, removing the feed wire(s) from the groove(s) in the ear guide, and then connecting and putting in a new feed wire with a new ear bud attached thereto. The method then ends at end step 512.

For the foregoing flowchart, it will be understood that the order of steps can be altered, and that some steps can be performed simultaneously. For example, step 504 may precede step 502. Further, it will be readily appreciated that not every method step provided is always necessary, and that further steps not set forth herein may also be included. For example, further process steps can include those involving the design and/or manufacture of audio headsets having the recited features. Other process steps can include the provision of a microphone with the headset and/or the reception and transmittal of sound by way of such a microphone. Steps involving the provision and/or use of multiple ear buds or other speakers with such a headset may also be applicable, as well as the ability to remove or replace individual components readily and without undue disassembly of the overall headset.

It should be understood that the devices, systems and methods described herein may be adapted and configured to function independently, or may also interact with other systems or applications, such as for example, a greater sound system including sound boards, outside microphones, outside speakers, computer processors, synthesizers, sound equalizers, and the like. Those skilled in the art will readily appreciate that any of the systems and methods of the disclosure, as well as the manufacture thereof, may include the use of various computer and network related software and hardware, such as programs, operating systems, memory storage devices, data input/output devices, data processors, servers with links to data communication systems, wireless or otherwise, and data transceiving terminals.

The various aspects, embodiments, implementations or features of the described embodiments can be used separately or in any combination. Various aspects of the described embodiments can be implemented by software, hardware or a combination of hardware and software. Such software and/or hardware could be used to provide digitized audio, and/or could be used to design and/or manufacture the ear guides, overall headsets, or any other components thereof. Computer readable medium can be any data storage device that can store data which can thereafter be read by a relevant computer system, such as to provide audio, design devices, or manufacture devices. Examples of computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed way.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. An audio headset adapted to provide audio to an individual user, comprising:
a support structure adapted to support the audio headset about the head of the individual user;
a first audio feed wire situated about the support structure and adapted to provide audio from an outside source to the individual user;
a first single ear speaker coupled to the first audio feed wire and adapted to provide the audio from said first audio feed wire to a single ear of the individual user; and
a first ear guide coupled to the support structure and adapted to be worn about the single ear of the individual user, wherein said first ear guide is further adapted for use with said first single ear speaker and includes a first groove running therethrough that is adapted to contain said first audio feed wire.

2. The audio headset of claim 1, wherein said first single ear speaker comprises an ear bud adapted to be inserted into the single ear of the user.

3. The audio headset of claim 1, wherein said first single ear speaker is arranged to be removable from and replaced to the single ear of the user while said audio headset is being worn by the user and without requiring any movement or adjustment of said support structure or said first ear guide.

4. The audio headset of claim 1, wherein said first single ear speaker dangles from said first ear guide via said first audio feed wire.

5. The audio headset of claim 1, wherein said first groove includes a rear opening at or near a back end of said first ear guide and runs substantially through the length thereof to at least one frontal opening at or near a front end of the first ear guide.

6. The audio headset of claim 1, wherein said first groove includes a plurality of frontal openings at or near a front end of the first ear guide.

7. The audio headset of claim 6, wherein said first audio feed wire is adapted to be adjustable to alter its exit of the first groove at more than one of the plurality of frontal openings.

8. The audio headset of claim 1, further including:
a second audio feed wire situated about the support structure and adapted to further provide the audio from the outside source to the individual user;
a second single ear speaker coupled to the second audio feed wire and adapted to provide the audio from said second audio feed wire to the other ear of the individual user; and
a second ear guide coupled to the support structure and adapted to be worn about the other ear of the individual user, wherein said second ear guide is further adapted for use with said second single ear speaker and includes a second groove running therethrough that is adapted to contain said second audio feed wire.

9. The audio headset of claim 8, wherein said first and second single ear speakers comprise separate ear buds adapted to be inserted into the ears of the user independently from each other.

10. The audio headset of claim 8, wherein said first ear guide and said second ear guide both extend around the head of the user to meet each other thereby.

11. The audio headset of claim 10, wherein said first groove meets and connects to said second groove.

12. The audio headset of claim 10, wherein said first ear guide and said second ear guide are integrally formed from a single piece of material.

13. The audio headset of claim 1, further including:
a microphone coupled to the support structure or the first ear guide and adapted to provide voice input from the user to the outside source.

14. The audio headset of claim 1, wherein said first audio feed wire and said first single ear speaker are readily separable, removable, and replaceable from said first ear guide and the remainder of the audio headset.

15. An audio system, comprising:
an audio source processor; and
one or more audio headsets adapted to provide audio from said audio source processor to one or more individual users, wherein each of said one or more audio headsets includes:
a support structure adapted to support the audio headset about the head of the individual user;
a first audio feed wire situated about the support structure and adapted to provide audio from an outside source to the individual user;
a first ear bud coupled to the first audio feed wire and adapted to be placed into or about a single ear of the individual user; and
a first ear guide adapted to be worn around an ear of the individual user and adapted for use with said first ear bud, wherein said first ear guide includes a channel running therethrough that is adapted to contain the first audio feed wire.

16. The audio system of claim 15, wherein said first ear bud is arranged to be removable from and replaced to the single ear of the user while said audio headset is being worn by the user and without requiring any movement or adjustment of said support structure or said first ear guide.

17. The audio system of claim 15, wherein said first groove includes a rear opening at or near a back end of said first ear guide and runs substantially through the length thereof to a plurality of frontal openings at or near a front end of the first ear guide, and wherein said first audio feed wire is adapted to be adjustable to alter its exit of the first groove at more than one of the plurality of frontal openings.

18. The audio system of claim 15, wherein each of said one or more audio headsets further includes:
a second audio feed wire situated about the support structure and adapted to further provide the audio from the outside source to the individual user;
a second ear bud coupled to the second audio feed wire and adapted to provide the audio from said second audio feed wire to the other ear of the individual user; and
a second ear guide coupled to the support structure and adapted to be worn about the other ear of the individual user, wherein said second ear guide is further adapted for use with said second ear bud and includes a second groove running therethrough that is adapted to contain said second audio feed wire.

19. The audio system of claim 15, wherein said first ear guide and said second ear guide both extend around the head of the user to meet each other thereby.

20. A method of providing audio to an individual user, the method comprising:
providing an audio headset to the individual user, wherein the audio headset includes at least a support structure that supports the audio headset about the head of the individual user, an audio feed wire situated about the support structure that provides audio from an outside source to the individual user, an ear bud coupled to the audio feed wire that provides the audio from the audio feed wire to an ear of the individual user, and an ear guide coupled to the support structure and including a groove running therethrough that contains the audio feed wire;
facilitating the wearing of the ear guide about the ear of the individual user such that the ear bud dangles therefrom via the audio feed wire and is insertable into the ear of the individual user; and
providing audio into the ear of the individual user via the ear bud when the ear bud is inserted into the ear of the individual user.
